(19) United States
(12) Patent Application Publication
(10) Pub. No.: US 2006/0056174 A1
(43) Pub. Date: Mar. 16, 2006

(54) Essence oil lamp

(76) Inventor: Chin-Sung Sun, Taipei County (TW)

Correspondence Address: Chin-Sung Sun, P. O. Box No. 6-57, Junghe, Taipei 235, TW

(21) Appl. No.: 10/968,879

(22) Filed: Oct. 21, 2004

(30) Foreign Application Priority Data
Sep. 10, 2004 (TW) 092220666

(51) Int. Cl. F21V 35/00

(52) U.S. Cl. 362/161

(57) ABSTRACT

An essence oil lamp includes a bottle having a penetrated inner opening therein, an upper opening facing an upper inner opening at a top end of the inner opening, a lower opening facing a lower inner opening at a bottom end of the inner opening, a fastening seat above the lamp seat and the bottle for accommodating a chip, a cotton thread below the lamp seat and for absorbing an essence oil, and a power line using either an AC or DC power supply connected to a joint further connected to a plug. When power supplying to the fastening seat to heat up the chip, the essence oil using a high temperature can be emanated. A power supply box is provided below the seat for accommodating a power storage body connected to the power line, thereby supplying the fastening seat with power for heating up the chip.

### BACKGROUND OF THE INVENTION

(a) Field of the Invention

The invention relates to an essence oil lamp comprising a bottle as a main body thereof, a penetrated inner opening in the bottle, an upper inner opening at a top end of the inner opening, an upper opening facing the upper inner opening, a lower inner opening at a bottom end of the inner opening, a lower opening facing the lower inner opening, a lamp seat above the bottle, a fastening seat above the lamp seat and for accommodating a chip, a cotton thread below the lamp seat and for absorbing an essence oil, and a power line using either an AC or DC power supply connected to a joint further connected to a plug. Thus, using the power device, power is supplied to the fastening seat to heat up the chip, thereby emanating the essence oil using a high temperature produced. In addition, a power supply box is provided below the seat and is for accommodating a power storage body connected to the power line. Therefore, the power line is enabled to directly supply the fastening seat with power for heating up the chip. The present invention requires electricity for about a minute only and effectively eliminates potential problems of short-circuits and accidental electric sparks as in prior inventions.

(b) Description of the Prior Art

Referring to FIG. 1, a prior aromatherapy lamp or an essence oil lamp comprises a main body thereof mounted with a shallow dish for placing an essence oil, and a heating device at a lower portion thereof. Wherein, the heating device generally uses alcohol for combustion, so as to supply the shallow dish above with heat and to further emanate a fragrance or a specific aromatherapeutic material from the essence held by the shallow dish.

It is to be noted that a temperature usually rises slowly when heating using the aforesaid lamp. However, the aromatherapy lamp or the essence oil lamp is required to be heated up to as high as 300 degrees Celsius so that no hazardous materials are produced by the essence oil. The reason behind is that, the aromatherapeutic oil contains isopropanol that produces hazardous materials when heated with low temperatures. Hence, the prior invention is considered as a rather inadequate device for having failed to heat with temperatures desired.

Therefore, it is a vital task of the invention as how to provide an essence oil lamp that overcomes the aforesaid shortcomings.

### SUMMARY OF THE INVENTION

To better understand the essence oil lamp according to the invention, detailed descriptions shall be given with the accompanying drawings below.

Referring to FIGS. 2 and 3, the invention comprises a bottle 8 as a main body thereof, a penetrated inner opening 12 in the bottle 8, an upper inner opening 13 at a top end of the inner opening 12, an upper opening 14 facing the upper inner opening 13, a lower inner opening 11 at a bottom end of the inner opening 12, a lower opening 9 facing the lower inner opening 11, a lamp seat 3 above the bottle 8, a fastening seat 2 above the lamp seat 3 and for accommodating a chip 1, a cotton thread 4 below the lamp seat 3 and for absorbing an essence oil, and a power line 5 using either an AC or DC power supply and connected to a joint 6 further connected to a plug 7. Wherein, using the power device, power is supplied to the fastening seat 2 to heat up the chip 1, thereby emanating the essence oil using a high temperature produced.

Referring to FIG. 5, the structure according to the invention also comprises a seat 9 having a power supply box 16 below. The power supply box 16 is for accommodating a power storage body 17 connected to the power line. The power line is thus enabled to directly supply the fastening seat 2 with power for heating up the chip 1, thereby emanating the essence oil using a high temperature produced.

### BRIEF DESCRIPTION OF THE DRAWINGS

FIG. 1 shows an elevational schematic view of a prior invention in use.

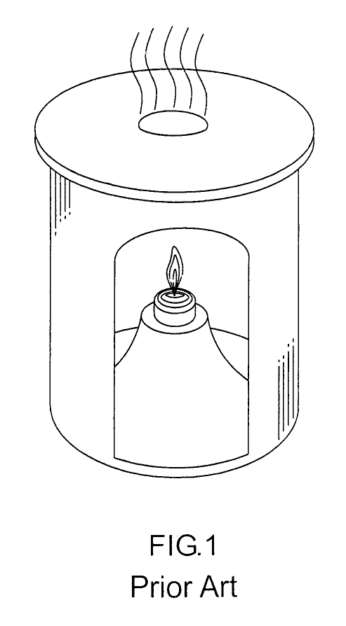

FIG. 2 shows a planar sectional schematic view of an assembly according to the invention.

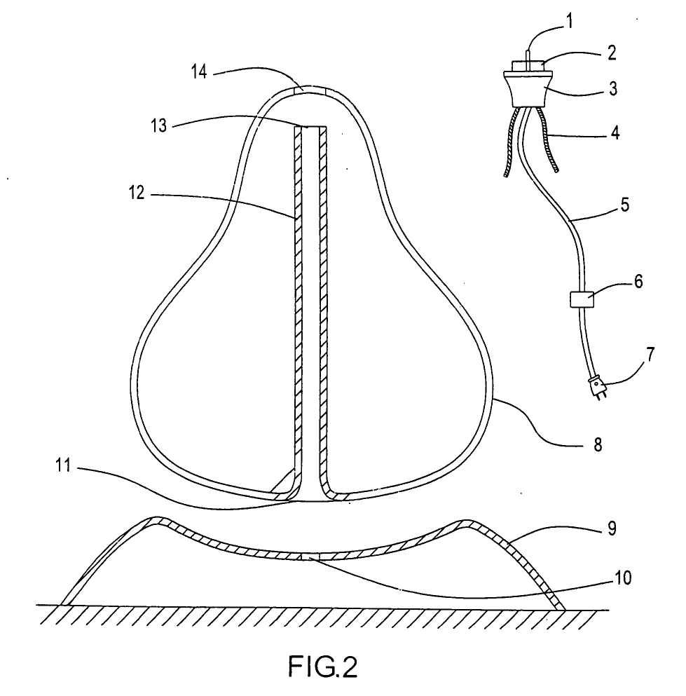

FIG. 3 shows an elevational schematic view of an assembly according to the invention.

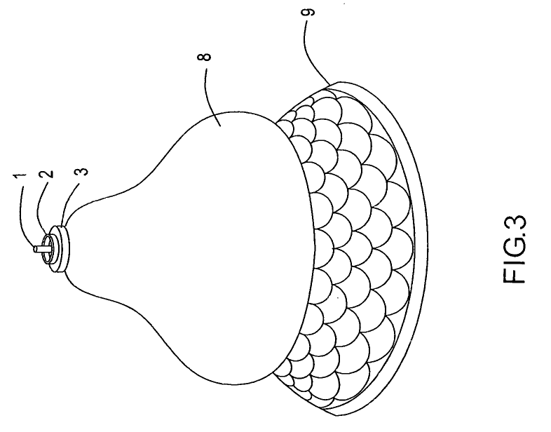

FIG. 4 shows a schematic view according to the invention in use.

FIG. 5 shows a schematic view of another embodiment in use according to the invention.

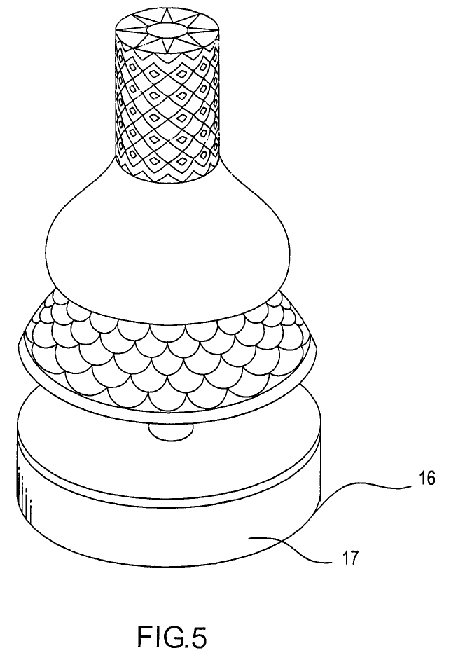

### DETAILED DESCRIPTION OF THE PREFERRED EMBODIMENTS

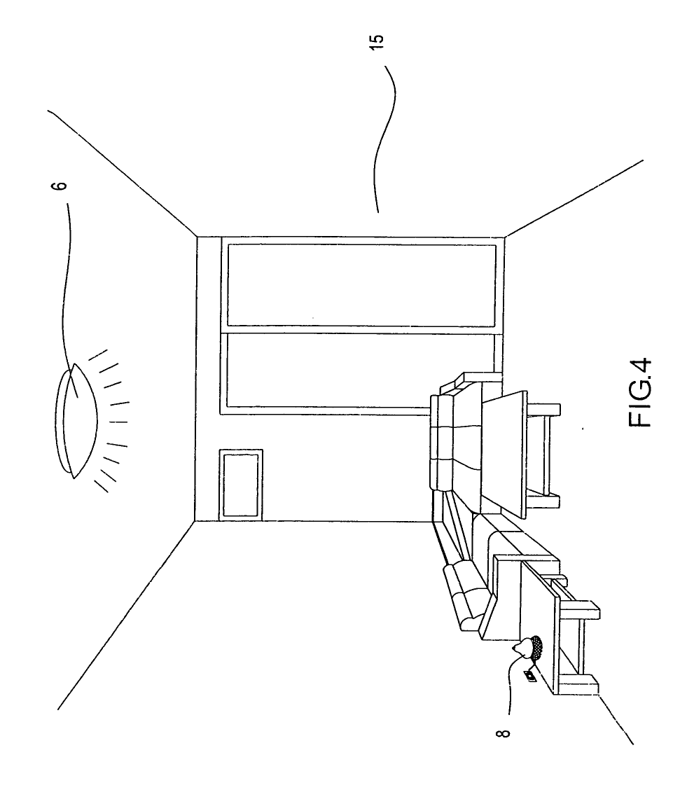

Referring to FIG. 4 showing an essence oil lamp according to the invention, when a user connects a power supply to the essence oil lamp according to the invention, the chip at an upper portion is instantaneously provided with a high temperature of over 300 degree Celsius. Using the high temperature of the chip, the essence oil in the bottle is rapidly emanated to fill up an entire room 15 to put the invention to application. The essence oil stored in the bottle is guided by the cotton thread, and passed through the lamp seat and fastening seat to reach the chip at the top. Through the power supply line, the chip is provided with power supplied to the fastening seat and heated, thereby emanating the essence oil using the high temperature produced.

To distinguish novelty and practicability of the invention, the present invention is compared with the prior invention.

The prior invention has drawbacks of:
1. slow temperature rise that likely leads to hazardous materials harmful to human bodies;
2. hazardous materials produced by isopropanol contained in the essence oil emanated using a low temperature;
3. prone to malfunctions;
4. lack of practical values; and
5. potential dangers of short-circuits and accidental electric sparks.

The present invention has excellences of:
1. rapid temperature rise free from producing hazardous materials to human bodies;
2. low production cost;
3. minimal possible malfunctions;
4. handy conveniences;
5. enhanced advancement;
6. industrial practical values; and
7. no potential dangers of short-circuits and accidental electric sparks.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. An essence oil lamp comprising a bottle as a main body, a penetrated inner opening in the bottle, an upper inner opening at a top end of the inner opening, an upper opening facing the upper inner opening, a lower inner opening at a bottom end of the inner opening, a lower opening facing the lower inner opening, and a lamp seat above the bottle; and being characterized that:
a fastening seat is devised above the lamp seat and is for accommodating a chip, a cotton thread is provided below the lamp seat and is for absorbing an essence oil, and a power line using either an AC or DC power supply is connected to a joint further connected to a plug; thus, using the power device, power is supplied to the fastening seat to heat up the chip, thereby emanating the essence oil using a high temperature produced; and
a power supply box is provided below the seat and is for accommodating a power storage body connected to the power line; the power line is thus enabled to directly supply the fastening seat with power for heating up the chip.
